(19) United States
(12) Patent Application Publication
(10) Pub. No.: US 2024/0298387 A1
(43) Pub. Date: Sep. 5, 2024

(54) COOKING APPLIANCE

(71) Applicant: Whirlpool Corporation, Benton Harbor, MI (US)

(72) Inventors: Xiaojun Guo, Shunde (CN); Ruimian Huang, Shunde (CN); Wenhao Xie, Shunde (CN); Lingling Zheng, Shenzhen (CN); Xiangzhou Zhu, Shenzhen (CN)

(73) Assignee: Whirlpool Corporation, Benton Harbor, MI (US)

(21) Appl. No.: 18/586,881

(22) Filed: Feb. 26, 2024

Related U.S. Application Data
(60) Provisional application No. 63/488,313, filed on Mar. 3, 2023.

(51) Int. Cl. H05B 6/64

(52) U.S. Cl. CPC H05B 6/6429

(57) ABSTRACT

A cooking appliance includes a body defining a cooking cavity, and a mounting plate including pivotably coupled first and second panels and first and second locking features that are coupled to the first and second panels, respectively. The mounting plate is operable between a folded condition, wherein the second panel is pivoted relative to the first panel such that the mounting plate fits within the cooking cavity and the first locking feature is disengaged from the second locking feature, and an extended condition in which the mounting plate supports the body in a mounted condition of the cooking appliance. The first and second panels are generally parallel and the first locking feature is engaged with the second locking feature to maintain the mounting plate in the extended condition. The first and second locking features become engaged with each other upon movement of the mounting plate to the extended condition.

### CROSS-REFERENCE TO RELATED APPLICATION

This application claims the benefit of priority under 35 U.S.C. § 119 of U.S. Provisional Application No. 63/488,313, filed Mar. 3, 2023, the entire contents of which are incorporated herein by reference.

### BACKGROUND OF THE DISCLOSURE

The present disclosure generally relates to a cooking appliance. More specifically, the present disclosure relates to a cooking appliance that includes a mounting plate that is operable between a folded condition and an extended condition.

### SUMMARY OF THE DISCLOSURE

According to an aspect of the present disclosure, a cooking appliance includes a body that defines a cooking cavity, and a mounting plate including a first panel, a second panel pivotably coupled to the first panel, a first locking feature coupled to the first panel, and a second locking feature coupled to the second panel. The mounting plate is operable between a folded condition and an extended condition. In the folded condition, the second panel is pivoted relative to the first panel such that the mounting plate is operable to fit within the cooking cavity and the first locking feature is disengaged from the second locking feature. In the extended condition, the mounting plate is configured to support the body in a mounted condition of the cooking appliance. The first and second panels extend generally parallel to each other and the first locking feature is engaged with the second locking feature to maintain the mounting plate in the extended condition. Further, the first and second locking features are configured to become engaged with each other upon movement of the mounting plate to the extended condition.

According to another aspect of the disclosure, a method of installing a cooking appliance includes removing a mounting plate from within a cooking cavity of the cooking appliance and mounting the cooking appliance to an external structure via the mounting plate.

According to yet another aspect of the disclosure, a cooking appliance includes a body that defines a cooking cavity, and a mounting plate that includes a first panel, a second panel pivotably coupled to the first panel, and at least one locking feature. The mounting plate is operable between a folded condition and an extended condition. In the folded condition, the second panel is pivoted relative to the first panel such that the mounting plate is operable to fit within the cooking cavity. In the extended condition, the mounting plate is operable to support the body in a mounted condition. Further, the at least one locking feature is configured to be engaged to maintain the mounting plate in the extended condition.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a microwave oven cooking appliance;

FIG. 2 is an exploded top perspective view of a mounting plate of a cooking appliance;

FIG. 3 is an exploded top perspective view of a mounting plate of a cooking appliance that includes a plurality of panels;

FIG. 4 is a top perspective view of a mounting plate of a cooking appliance in an extended condition, wherein a first locking feature coupled to a first panel of the mounting plate is engaged with a second locking feature coupled to a second panel of the mounting plate;

FIG. 5 is an enlarged top perspective view of area V of FIG. 4 illustrating the first and second locking features engaged with each other to maintain the mounting plate in the extended condition;

FIG. 6 is a top perspective view of a mounting plate in a folded condition;

FIG. 7 is a front elevational view of a microwave oven cooking appliance that includes a body that defines a cooking cavity and a mounting plate in a folded condition positioned within the cooking cavity defined by the body of the cooking appliance;

FIG. 8 is a perspective view of a mounting plate in a folded condition, illustrating a hinge assembly;

FIG. 9 is a perspective view of the hinge assembly of FIG. 8 in a variety of pivotal positions; and

FIG. 10 is a flow diagram of a method of installing a cooking appliance.

The components in the figures are not necessarily to scale, emphasis instead being placed upon illustrating the principles described herein.

### DETAILED DESCRIPTION

The present illustrated embodiments reside primarily in combinations of method steps and apparatus components related to a cooking appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

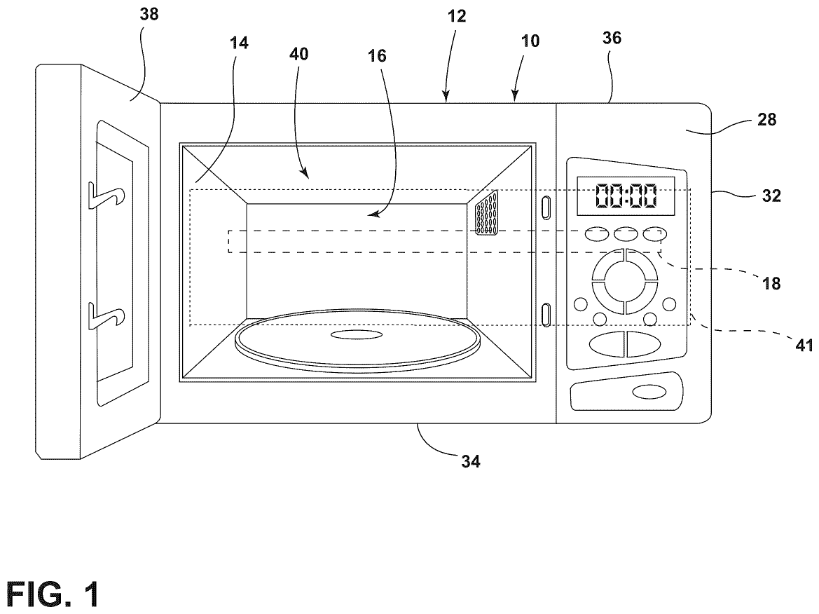

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific apparatus illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-9, reference numeral 10 generally designates a cooking appliance. As illustrated in FIG. 1, in some implementations, the cooking appliance 10 can be a microwave oven 12. The microwave oven 12 includes a body 14 that defines a cooking cavity 16. A mounting plate 18 of the microwave oven 12 includes a first panel 20, a second panel 22 that is pivotably coupled to the first panel 20, a first locking feature 24 that is coupled to the first panel 20, and a second locking feature 26 that is coupled to the second panel 22. The mounting plate 18 is operable between a folded condition and an extended condition. In the folded condition, the second panel 22 is pivoted relative to the first panel 20 such that the mounting plate 18 is operable to fit within the cooking cavity 16. The first locking feature 24 is disengaged from the second locking feature 26 in the folded condition of the mounting plate 18. In the extended condition of the mounting plate 18, the first and second panels 20, 22 extend generally parallel to each other, and the first locking feature 24 is engaged with the second locking feature 26 to maintain the mounting plate 18 in the extended condition. The mounting plate 18 is configured to support the body 14 of the microwave oven 12 in a mounted condition of the microwave oven 12. The first and second locking features 24, 26 are configured to become engaged with each other upon movement of the mounting plate 18 to the extended condition.

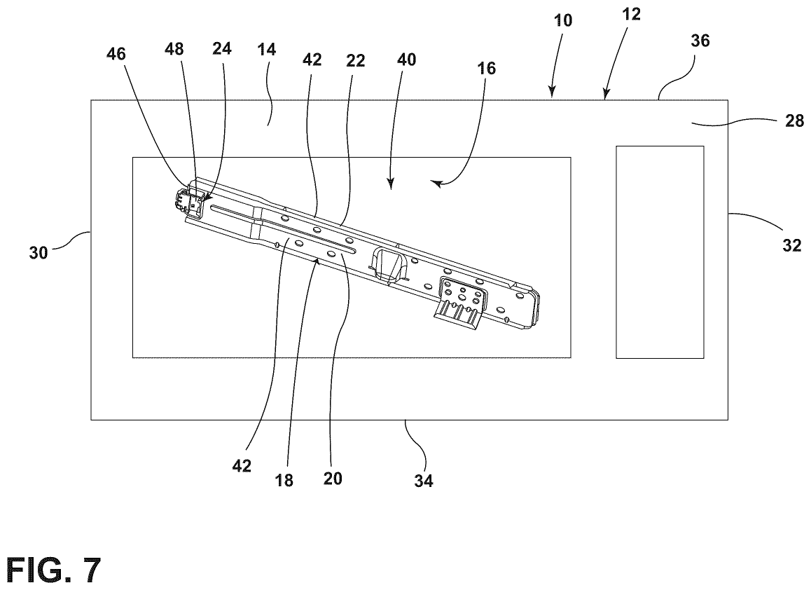

Referring now to FIGS. 1 and 7, the illustrated cooking appliance 10 is in the form of a microwave oven 12. A variety of types of cooking appliances 10 are contemplated. For example, the cooking appliance 10 may be a microwave oven 12, a toaster oven, a gas and/or electric oven, such as a wall-mounted oven, and/or a variety of other types of appliances configured for cooking food. As illustrated in FIG. 1, the cooking appliance 10 includes a body 14. The body 14 of the cooking appliance 10 can include a front side 28, a rear side (not shown), a left side 30, a right side 32, a bottom side 34, and a top side 36. In the embodiment illustrated in FIG. 1, the front side 28 of the cooking appliance 10 defines an opening 40 to the cooking cavity 16 that is defined by the body 14. In various implementations, the cooking cavity 16 is configured to receive food items therein for cooking, baking, and/or a variety of other types of food preparations utilizing heat. As further illustrated in FIG. 1, the cooking appliance 10 includes a door 38 that is operable to selectively cover the opening 40 that provides access to the cooking cavity 16 defined by the body 14 of the cooking appliance 10.

Referring now to FIGS. 1-4, the cooking appliance 10 is operable to enter a mounted condition, wherein the cooking appliance 10 is mounted to an external structure 41 (e.g., wall, ceiling, cabinet structure, etc.). In various implementations, the cooking appliance 10 is mounted to the external structure 41 via the mounting plate 18. The mounting plate 18 can be disposed on the rear side and/or the top side 36 of the cooking appliance 10. It is contemplated that the mounting plate 18 may be disposed on various sides of the body 14 of the cooking appliance 10, in various implementations.

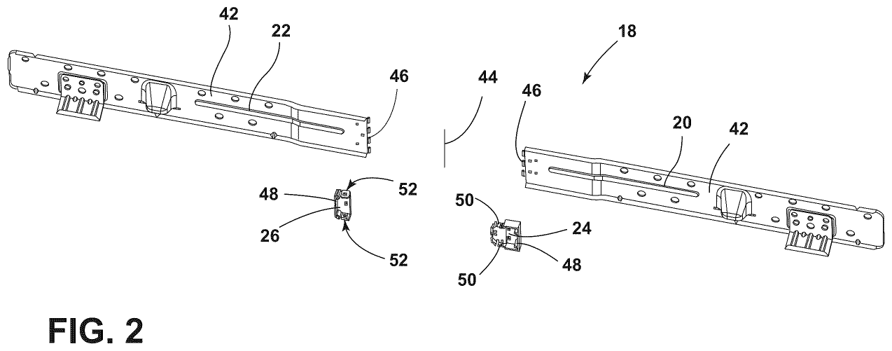

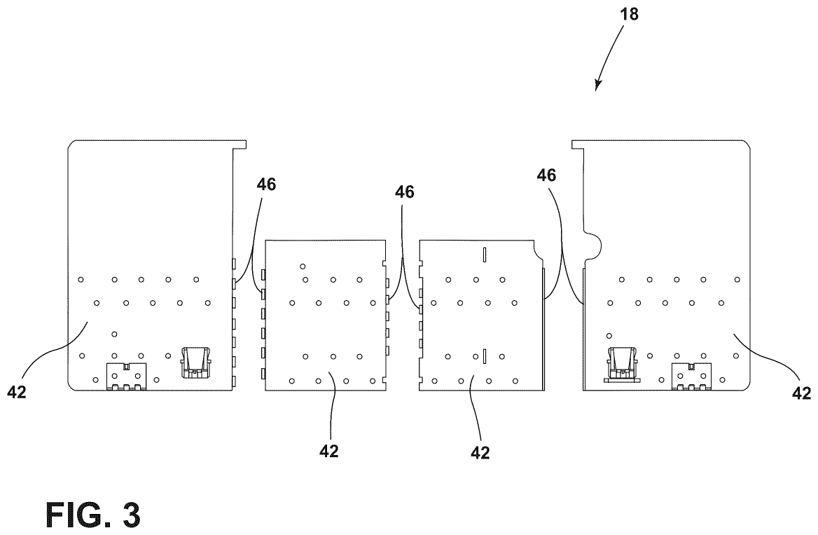

With reference now to FIGS. 2-6, the mounting plate 18 includes a plurality of panels 42. For example, as illustrated in FIG. 2, the mounting plate 18 includes the first panel 20 and the second panel 22. In some embodiments, the mounting plate 18 can include more than two panels 42. For example, in the embodiment illustrated in FIG. 3, the mounting plate 18 includes four panels 42 that are configured to be operably coupled with each other. The plurality of panels 42 of the mounting plate 18 are configured to be pivotably coupled with each other. In the embodiment illustrated in FIG. 2, the first panel 20 and the second panel 22 are configured to be pivotably coupled to each other via a pivot pin 44 that is received within respective hinge portions 46 of the first and second panels 20, 22.

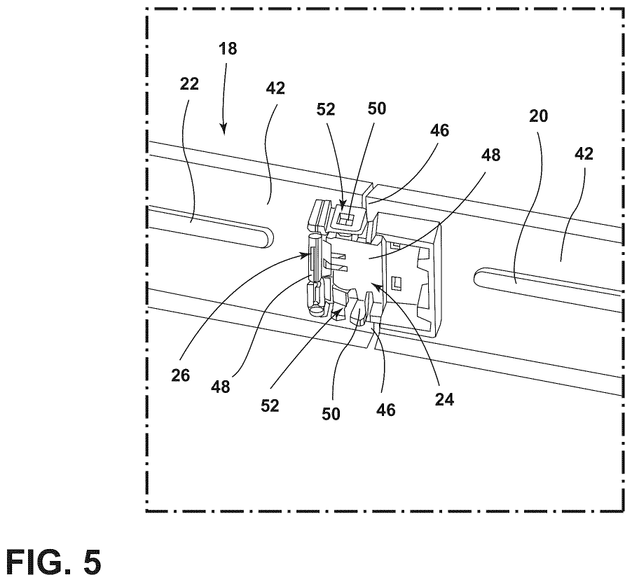

The mounting plate 18 includes at least one locking feature 48. In various implementations, the mounting plate 18 includes a plurality of locking features 48. As illustrated in FIGS. 2, 4, and 5, the mounting plate 18 includes the first locking feature 24 that is coupled to the first panel 20, and the second locking feature 26 that is coupled to the second panel 22. As illustrated in FIG. 5, the first and second locking features 24, 26 are coupled to the first and second panels 20, 22, respectively, at locations proximate to the hinge portions 46 that pivotably couple the first and second panels 20, 22 to each other. In the illustrated embodiment, the first locking feature 24 extends beyond the hinge portion 46 of the first panel 20. The first and second locking features 24, 26 are configured to be releasably engaged with each other. In the embodiment illustrated in FIG. 5, the first locking feature 24 includes snap fit prongs 50, and the second locking feature 26 includes receiving apertures 52. The snap fit prongs 50 of the first locking feature 24 are configured to be received within the receiving apertures 52 defined by the second locking feature 26 while the first and second locking features 24, 26 are releasably engaged with each other. A variety of types of locking features 48 that are configured to be engaged with each other are contemplated (e.g., mating engagement features, snap fit engagement features, tongue and groove engagement features, magnets, etc.).

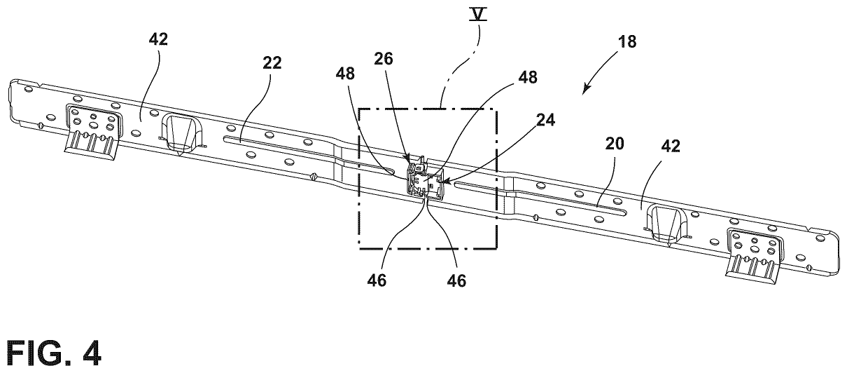

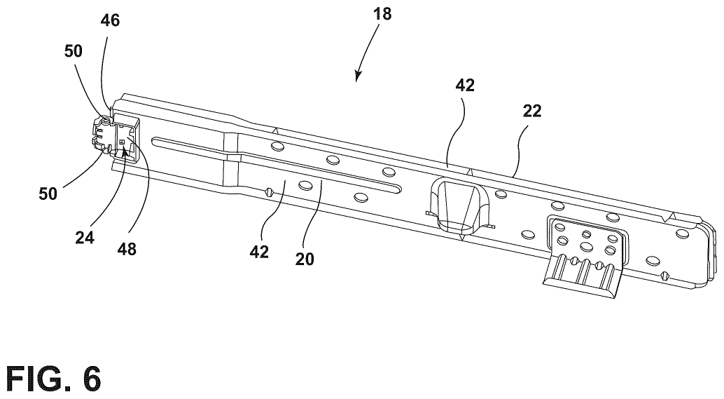

Referring now to FIGS. 4-6, the mounting plate 18 is operable between the extended condition, as illustrated in FIG. 4, and the folded condition, as illustrated in FIG. 6. In the embodiment illustrated in FIGS. 4 and 6, the first and second panels 20, 22 are elongated panels 42 that are pivotably coupled with each other. As illustrated in FIG. 4, the lengths of the first and second panels 20, 22 are generally parallel with each other in the extended condition of the mounting plate 18. The mounting plate 18 is configured to support the body 14 in the mounted condition of the microwave oven 12 while the mounting plate 18 is in the extended condition. In various implementations, the at least one locking feature 48 is configured to releasably maintain the mounting plate 18 in the extended condition while the mounting plate 18 is in the extended condition. For example, as illustrated in FIGS. 4 and 5, in the extended condition of the mounting plate 18, the first locking feature 24 is engaged with the second locking feature 26. In various embodiments, the at least one locking feature 48 is configured to be engaged to maintain the mounting plate 18 in the extended condition upon movement of the mounting plate 18 to the extended condition. For example, in the embodiment illustrated in FIGS. 4-6, the first and second locking features 24, 26 are configured to become engaged with each other upon movement of the mounting plate 18 to the extended condition from the folded condition.

Referring still to FIGS. 4-6, the first and second panels 20, 22 are operable to pivot relative to each other to move the mounting plate 18 from the extended condition to the folded condition. In the folded condition of the mounting plate 18, the at least one locking feature 48 is disengaged, such that the first and second panels 20, 22 are free to pivot relative to each other toward the extended condition. In the embodiment illustrated in FIG. 6, the first locking feature 24 is disengaged from the second locking feature 26. As illustrated in FIG. 6, a length of the mounting plate 18 while in the folded condition is less than a length of the mounting plate 18 in the extended condition. In various implementations, the mounting plate 18 is operable to fit within the cooking cavity 16 defined by the body 14 of the cooking appliance 10 in the folded condition of the mounting plate 18. For example, as illustrated in FIG. 7, the mounting plate 18 in the folded condition is received within the cooking cavity 16 defined by the body 14 of the cooking appliance 10. In various implementations, the mounting plate 18 does not fit within the cooking cavity 16 while the mounting plate 18 is in the extended condition.

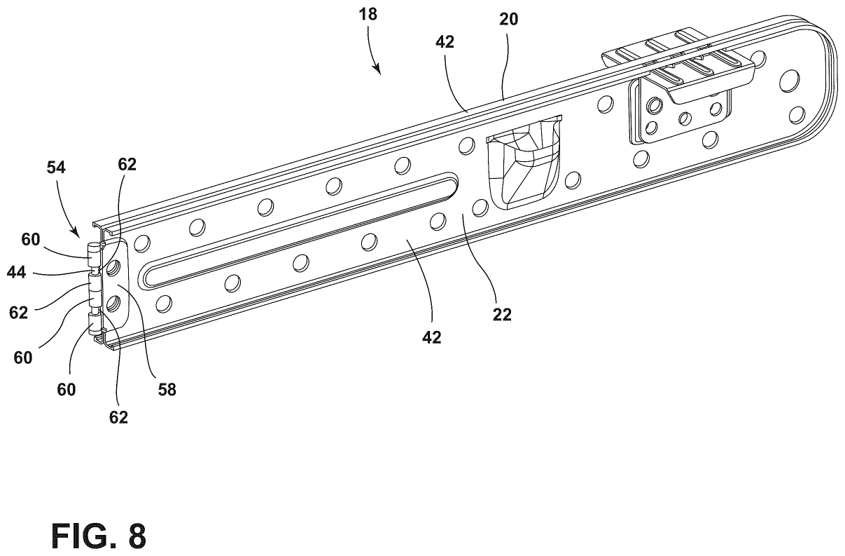

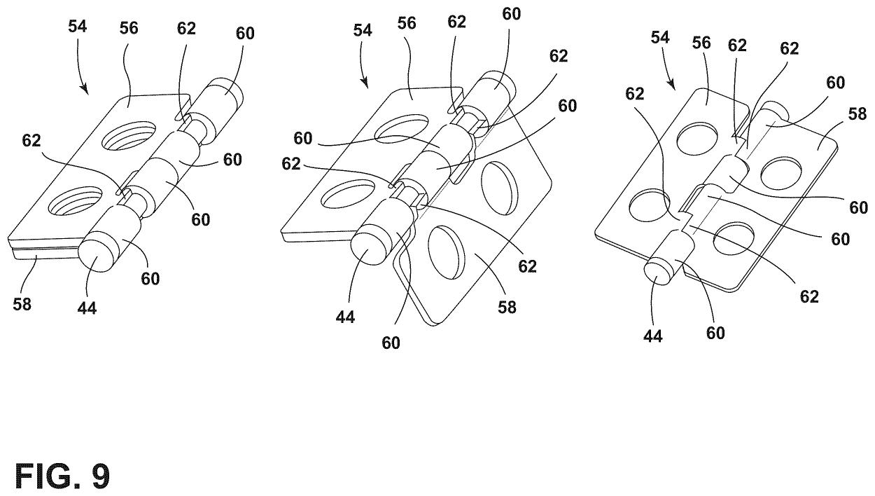

Referring now to FIGS. 8 and 9, in some embodiments, the mounting plate 18 can include a hinge assembly 54. The hinge assembly 54 may be operably coupled to the first and second panels 20, 22 and may be configured to facilitate pivoting of the first panel 20 relative to the second panel 22. In some embodiments, the hinge assembly 54 may pivotably couple the first panel 20 and the second panel 22 and may be configured to allow the first panel 20 to pivot relative to the second panel 22 to move the mounting plate 18 between the folded condition and the extended condition. In some implementations, the hinge assembly 54 is configured to prevent pivoting of the first and second panels 20, 22 beyond the extended condition of the mounting plate 18. In other words, the hinge assembly 54 can be configured to facilitate pivoting of the first panel 20 relative to the second panel 22 to a degree that is less than or equal to about 180 degrees from the folded condition of the mounting plate 18 to the extended condition of the mounting plate 18 and prevent further pivotal movement in the same pivotal direction beyond the extended condition of the mounting plate 18.

As illustrated in FIG. 9, the hinge assembly 54 includes the pivot pin 44. The hinge assembly 54 further includes a first leaf 56 coupled to the first panel 20 and the second leaf 58 coupled to the second panel 22. The first and second leaves 56, 58 include a plurality of sleeve portions 60. The sleeve portions 60 of the first and second leaves 56, 58 receive the pivot pin 44 therethrough and rotate about the pivot pin 44 to facilitate pivotal movement of the first panel 20 relative to the second panel 22. In various embodiments, the sleeve portions 60 of the first leaf 56 alternate with the sleeve portions 60 of the second leaf 58 along a length of the pivot pin 44. As illustrated in FIG. 9, stops 62 protrude outward from the sleeve portions 60 of the first and second leaves 56, 58 in a direction parallel to the length of the pivot pin 44. The stops 62 extend along a portion of the circumference of the pivot pin 44, such that pivotal movement of first and second leaves 56, 58 about the pivot pin 44 is allowed within a given range (e.g., 160 degrees, 180 degrees, 200 degrees, etc.), and prevented beyond the given range due to interference between corresponding stops 62 of the first and second leaves 56, 58, respectively, as illustrated in FIG. 9. The stops 62 of the hinge assembly 54 can allow the first and second panels 20, 22 to pivot within a limited range that enables the mounting plate 18 to extend from the folded condition to the extended condition without extending beyond the extended condition.

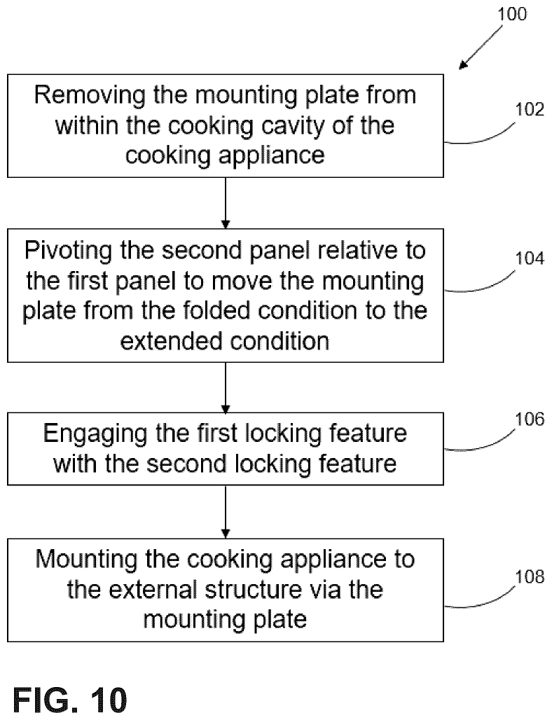

Referring now to FIG. 10, a method 100 of installing a cooking appliance 10 includes a step 102 of removing a mounting plate 18 from within a cooking cavity 16 of the cooking appliance 10. In various implementations, the mounting plate 18 may initially be positioned within the cooking cavity 16 of the cooking appliance 10 for the purpose of shipping the cooking appliance 10 in a compact fashion. As such, a person installing the cooking appliance 10 removes the mounting plate 18 from within the cooking cavity 16 of the cooking appliance 10 at step 102. In various implementations, the mounting plate 18 includes the first panel 20 and the second panel 22 that is pivotably coupled to the first panel 20. The mounting plate 18 may be operable between the folded condition, wherein the second panel 22 is pivoted relative to the first panel 20 such that the mounting plate 18 is operable to fit within the cooking cavity 16, and an extended condition. In the extended condition of the mounting plate 18, the mounting plate 18 may be operable to support the cooking appliance 10 relative to an external structure 41 to which the cooking appliance 10 is configured to be mounted. In various implementations, the first and second panels 20, 22 of the mounting plate 18 extend generally parallel to each other in the extended condition of the mounting plate 18. The mounting plate 18 may be in the folded condition during the step 102 of removing the mounting plate 18 from within the cooking cavity 16, as illustrated in FIG. 7.

Referring still to FIG. 10, the method 100 of installing the cooking appliance 10 may include a step 104 of pivoting the second panel 22 relative to the first panel 20 to move the mounting plate 18 from the folded condition to the extended condition. In various implementations, the mounting plate 18 cannot fit within the cooking cavity 16 of the cooking appliance 10 while in the extended condition. As such, in various implementations, the step 104 of pivoting the second panel 22 relative to the first panel 20 to move the mounting plate 18 from the folded condition to the extended condition occurs after performance of the step 102 of removing the mounting plate 18 from within the cooking cavity 16 of the cooking appliance 10.

Referring still to FIG. 10, the method 100 of installing the cooking appliance 10 may include a step 106 of engaging the first locking feature 24 that is coupled to the first panel 20 with the second locking feature 26 that is coupled to the second panel 22 to maintain the mounting plate 18 in the extended condition. The first and second locking features 24, 26 can be releasably engaged with each other. In an exemplary implementation, the first locking feature 24 includes at least one snap fit prong 50, and the second locking feature 26 includes at least one receiving aperture 52 configured to receive the at least one snap fit prong 50 to releasably engage the first and second locking features 24, 26. In some implementations, pivotal movement of the first and second panels 20, 22 to the extended position that occurs at step 104 prompts the engagement of the first and second locking features 24, 26 that occurs at step 106.

Referring still to FIG. 10, the method 100 of installing the cooking appliance 10 includes a step 108 of mounting the cooking appliance 10 to an external structure 41 via the mounting plate 18. A variety of types of external structures 41 are contemplated (e.g., wall, ceiling, cabinet structure, etc.). Further, the mounting plate 18 may be disposed on various portions of the cooking appliance 10 in order to support the cooking appliance 10 relative to the external structure 41. For example, the mounting plate 18 may be disposed on the rear side and/or the top side 36 of the cooking appliance 10. Further, it is contemplated that the mounting plate 18 may cooperate with other components, such as fasteners (e.g., bolts, screws, etc.), to mount the cooking appliance 10 to the external structure 41.

The cooking appliance of the present disclosure may provide a variety of advantages. First, the at least one locking feature 48 becoming engaged upon movement of the mounting plate 18 from the folded condition to the extended condition may provide for intuitive assembly of the cooking appliance 10. Second, the mounting plate 18 being operable to fit within the cooking cavity 16 in the folded condition of the mounting plate 18 may conveniently allow for the mounting plate 18 to be stored within the cooking cavity 16 of the cooking appliance 10 during shipment of the cooking appliance 10, which may allow for a more compact packaging system.

According to an aspect of the present disclosure, a cooking appliance includes a body that defines a cooking cavity, and a mounting plate including a first panel, a second panel pivotably coupled to the first panel, a first locking feature coupled to the first panel, and a second locking feature coupled to the second panel. The mounting plate is operable between a folded condition and an extended condition. In the folded condition, the second panel is pivoted relative to the first panel such that the mounting plate is operable to fit within the cooking cavity and the first locking feature is disengaged from the second locking feature. In the extended condition, the mounting plate is configured to support the body in a mounted condition of the cooking appliance. The first and second panels extend generally parallel to each other and the first locking feature is engaged with the second locking feature to maintain the mounting plate in the extended condition. Further, the first and second locking features are configured to become engaged with each other upon movement of the mounting plate to the extended condition.

According to another aspect, the first and second locking features are configured to be releasably engaged with each other.

According to another aspect, the first locking feature includes at least one snap fit prong and the second locking feature includes at least one receiving aperture that is configured to receive the at least one snap fit prong to maintain the first and second panels in the extended condition.

According to another aspect, the mounting plate includes a hinge assembly that is operably coupled to the first and second panels and configured to facilitate pivotal movement of the first panel relative to the second panel.

According to another aspect, the hinge assembly is configured to restrict pivoting of the first and second panels beyond the extended condition of the mounting plate.

According to another aspect, the hinge assembly is configured to restrict pivoting of the first and second panels beyond the extended condition, such that the pivotal range of motion of the second panel relative to the first panel is not more than about 180 degrees.

According to another aspect, the hinge assembly includes a pivot pin, a first leaf coupled to the first panel and having a plurality of sleeve portions through which the pivot pin extends and at least one stop that extends about a portion of a circumference of the pivot pin, and a second leaf coupled to the second panel and having a plurality of sleeve portions through which the pivot pin extends and at least one stop that extends about a portion of a circumference of the pivot pin. The sleeve portions of the first and second leaves are configured to rotate about the pivot pin to facilitate pivotal movement of the first panel relative to the second panel, the sleeve portions of the first leaf alternate with the sleeve portions of the second leaf along a length of the pivot pin, and the at least one stop of the first leaf and the at least one stop of the second leaf abut each other in the extended position of the mounting plate to restrict pivotal movement of the first and second panels beyond the extended condition.

According to another aspect, the cooking appliance is a microwave oven.

According to another aspect of the disclosure, a method of installing a cooking appliance includes removing a mounting plate from within a cooking cavity of the cooking appliance and mounting the cooking appliance to an external structure via the mounting plate.

According to another aspect, the mounting plate includes a first panel and a second panel pivotably coupled to the first panel and is operable between a folded condition, wherein the second panel is pivoted relative to the first panel such that the mounting plate is operable to fit within the cooking cavity, and an extended condition, in which the mounting plate is operable to support the cooking appliance relative to the external structure.

According to another aspect, the mounting plate is in the folded condition during the step of removing the mounting plate from within the cooking cavity.

According to another aspect, the first and second panels extend generally parallel to each other in the extended condition of the mounting plate.

According to another aspect, the method further includes the step of pivoting the second panel relative to the first panel to move the mounting plate from the folded condition to the extended condition.

According to another aspect, the method further includes the step of engaging a first locking feature coupled to the first panel with a second locking feature coupled to the second panel to maintain the mounting plate in the extended condition.

According to another aspect, the first locking feature includes at least one snap fit prong, and the second locking feature includes at least one receiving aperture configured to receive the at least one snap fit prong to releasably engage the first and second locking features.

According to another aspect, movement of the first and second panels to the extended condition prompts engagement of the first and second locking features.

According to yet another aspect of the disclosure, a cooking appliance includes a body that defines a cooking cavity, and a mounting plate that includes a first panel, a second panel pivotably coupled to the first panel, and at least one locking feature. The mounting plate is operable between a folded condition and an extended condition. In the folded condition, the second panel is pivoted relative to the first panel such that the mounting plate is operable to fit within the cooking cavity. In the extended condition, the mounting plate is operable to support the body in a mounted condition. Further, the at least one locking feature is configured to be engaged to maintain the mounting plate in the extended condition.

According to another aspect, the first and second panels extend generally parallel to each other in the extended condition.

According to another aspect, the at least one locking feature is configured to become engaged to maintain the mounting plate in the extended condition upon movement of the mounting plate to the extended condition.

According to another aspect, the mounting plate includes a hinge assembly configured to restrict pivotal movement of the first and second panels relative to each other beyond the extended condition of the mounting plate.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

What is claimed is:

1. A cooking appliance, comprising:
a body that defines a cooking cavity; and
a mounting plate, comprising:
a first panel;
a second panel pivotably coupled to the first panel;
a first locking feature coupled to the first panel; and
a second locking feature coupled to the second panel, the mounting plate being operable between a folded condition, wherein the second panel is pivoted relative to the first panel such that the mounting plate is operable to fit within the cooking cavity and the first locking feature is disengaged from the second locking feature, and an extended condition in which the mounting plate is configured to support the body in a mounted condition of the cooking appliance, wherein the first and second panels extend generally parallel to each other and the first locking feature is engaged with the second locking feature to maintain the mounting plate in the extended condition, and further wherein the first and second locking features are configured to become engaged with each other upon movement of the mounting plate to the extended condition.

2. The cooking appliance of claim 1, wherein the first and second locking features are configured to be releasably engaged with each other.

3. The cooking appliance of claim 2, wherein the first locking feature includes at least one snap fit prong and the second locking feature includes at least one receiving aperture that is configured to receive the at least one snap fit prong to maintain the first and second panels in the extended condition.

4. The cooking appliance of claim 1, wherein the mounting plate comprises:
a hinge assembly that is operably coupled to the first and second panels and configured to facilitate pivotal movement of the first panel relative to the second panel.

5. The cooking appliance of claim 4, wherein the hinge assembly is configured to restrict pivoting of the first and second panels beyond the extended condition of the mounting plate.

6. The cooking appliance of claim 5, wherein the hinge assembly is configured to restrict pivoting of the first and second panels beyond the extended condition, such that the pivotal range of motion of the second panel relative to the first panel is not more than about 180 degrees.

7. The cooking appliance of claim 5, wherein the hinge assembly comprises:
a pivot pin;
a first leaf coupled to the first panel and having a plurality of sleeve portions through which the pivot pin extends and at least one stop that extends about a portion of a circumference of the pivot pin; and
a second leaf coupled to the second panel and having a plurality of sleeve portions through which the pivot pin extends and at least one stop that extends about a portion of a circumference of the pivot pin, wherein the sleeve portions of the first and second leaves are configured to rotate about the pivot pin to facilitate pivotal movement of the first panel relative to the second panel, the sleeve portions of the first leaf alternate with the sleeve portions of the second leaf along a length of the pivot pin, and the at least one stop of the first leaf and the at least one stop of the second leaf abut each other in the extended position of the mounting plate to restrict pivotal movement of the first and second panels beyond the extended condition.

8. The cooking appliance of claim 1, wherein the cooking appliance is a microwave oven.

9. A method of installing a cooking appliance, comprising:
removing a mounting plate from within a cooking cavity of the cooking appliance; and
mounting the cooking appliance to an external structure via the mounting plate.

10. The method of claim 9, wherein the mounting plate includes a first panel and a second panel pivotably coupled to the first panel and is operable between a folded condition, wherein the second panel is pivoted relative to the first panel such that the mounting plate is operable to fit within the cooking cavity, and an extended condition, in which the mounting plate is operable to support the cooking appliance relative to the external structure.

11. The method of claim 10, wherein the mounting plate is in the folded condition during the step of removing the mounting plate from within the cooking cavity.

12. The method of claim 10, wherein the first and second panels extend generally parallel to each other in the extended condition of the mounting plate.

13. The method of claim 10, further comprising the step of:
pivoting the second panel relative to the first panel to move the mounting plate from the folded condition to the extended condition.

14. The method of claim 13, further comprising the step of:
engaging a first locking feature coupled to the first panel with a second locking feature coupled to the second panel to maintain the mounting plate in the extended condition.

15. The method of claim 14, wherein the first locking feature includes at least one snap fit prong, and the second locking feature includes at least one receiving aperture configured to receive the at least one snap fit prong to releasably engage the first and second locking features.

16. The method of claim 14, wherein movement of the first and second panels to the extended condition prompts engagement of the first and second locking features.

17. A cooking appliance, comprising:
a body that defines a cooking cavity; and
a mounting plate that includes a first panel, a second panel pivotably coupled to the first panel, and at least one locking feature, the mounting plate being operable between a folded condition, wherein the second panel is pivoted relative to the first panel such that the mounting plate is operable to fit within the cooking cavity, and an extended condition, in which the mounting plate is operable to support the body in a mounted condition, wherein the at least one locking feature is configured to be engaged to maintain the mounting plate in the extended condition.

18. The cooking appliance of claim 17, wherein the first and second panels extend generally parallel to each other in the extended condition.

19. The cooking appliance of claim 17, wherein the at least one locking feature is configured to become engaged to maintain the mounting plate in the extended condition upon movement of the mounting plate to the extended condition.

20. The cooking appliance of claim 17, wherein the mounting plate includes a hinge assembly configured to restrict pivotal movement of the first and second panels relative to each other beyond the extended condition of the mounting plate.
